(19) United States
(12) Patent Application Publication
(10) Pub. No.: US 2012/0126954 A1
(43) Pub. Date: May 24, 2012

(54) Forklift radio frequency identification apparatus

(75) Inventors: Kevin J. Kail, Great Falls, VA (US); Jason Kummerl, Warren, MI (US)

(73) Assignee: epcSolutions, Inc.

(21) Appl. No.: 13/373,545

(22) Filed: Nov. 18, 2011

Related U.S. Application Data
(60) Provisional application No. 61/344,944, filed on Nov. 24, 2010.

(51) Int. Cl. G06K 7/01

(52) U.S. Cl. 340/10.6

(57) ABSTRACT

A forklift RFID system on a forklift for reading individual plastic pallets having identical RFID tags in each corner in a stack of pallets. The forklift has a body, a mast mounted to the body and a fork assembly including forks moveably mounted on the mast. A RFID antenna assembly is secured in a fixed position on each side of the forklift above the wheel wells of the forklift and a RFID reader is positioned on the fork and hard wired to the RFID antenna assembly. The antenna assembly has a patch antenna mounted in a cylindrical body which has a bracket secured thereto. The distal end of the bracket has a magnet secured thereto which is mounted on the forklift body.

### RELATED APPLICATIONS

The present application is related to and claims priority from U.S. Provisional Patent Application No. 61/344,944 filed Nov. 24, 2010.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

The present invention relates to radio frequency identification (RFID) systems used with a forklift for identifying and tracking individual and stacked pallets.

2. Description of the Prior Art

Pallets are used worldwide to aid in the transport of products of various kinds, and are generally moved with the aid of a forklift truck or forklift. Because the pallets can be lifted, moved, and stored easily, they make the transportation of products simple and fast.

Conventional pallets are square or rectangular and define areas beneath which the forks of a forklift can enter to lift the pallet and are stored in stacks for later use. Typically pallets are constructed of wood and the individual pieces of the pallet are nailed, stapled, or otherwise fastened together. Currently, an improved plastic pallet has come on the market which is uniformly sized and provides greater resistance to the negative effects of moisture, such as mold or rotting. These pallets are provided with RFID tags on two or more corners.

RFID tags are well-known and typically include an integrated circuit (IC) that is operatively coupled to a tag antenna. The RFID tags used in the pallets of the present invention preferably resonate in a frequency range of 900 to 930 MHz which enables an RFID reader to interrogate the tags.

The IC associated with an RFID tag typically includes a certain amount of memory in which a tag identifier is stored and perhaps other information related to the tag. When an RFID antenna transmits energy to interrogate the RFID tag, the tag responds with information from which an RFID reader can obtain the RFID tag identifier. The data obtained by the RFID reader is then compared to entries in a database of identifiers so that individual pallets are identified and recorded. In that manner, information regarding each specific pallet may be obtained, updated, and provided to a user for transportation, billing, storage or inventory.

Many companies own or lease pallets, however, for large pallet usage, third party owners of pallets lease them to other companies for their use. Following the use of a pallet in one destination, the pallets might be returned to the lessor, back to the user entity, another entity, or to a specific location for reuse, reconditioning, repair, or disposal. For pallets with RFID tags, up-to-date information concerning the pallet is electronically entered in a database and the tag is associated with information about the current status and the history of the pallet. Thus, tagging the pallet can help record the location of the pallet, the condition of the pallet, the time the pallet spends at any particular pallet handler, the destination and routing schedule, and history of the pallet including pallet repairs, and other information of interest to the user or owner, or both. This and other information can be obtained quickly and easily from each pallet by simply using an RFID reader to interrogate the RFID tags associated with the pallet. This information is generally obtained from an RFID reader on a forklift truck, allowing the RFID tags associated with each pallet in a stack of pallets to be interrogated, and the location of a particular pallet can be tracked within a warehouse, distribution center, or other facility.

Forklifts pose a challenging environment for RFID to work effectively. The bulk of the forklift is made of metal which can interfere with the RF communication and forklifts are driven a fast speeds and are constantly bumping into objects so all mounted parts, namely the antenna and reader(s) on the forklift must be secured. In addition large numbers of hoses, cables and pulleys are required to operate the forklift which needs to be unobstructed for the forklift to move correctly and be accessible for maintenance. Most antennae cables are standard coaxial cables which have limited flexibility that will make them difficult to thread. Furthermore, the carriage and forks tilt, move and slide in multiple ways both horizontal and vertical which restrict the areas for placing antennas and readers and interfere with RFID readouts.

Various patents and publications have described the use of RFID tags with pallets. For example, Netherlands Publication Document 9401836 describes a process and system for the identification of pallets, in which an RFID tag (transponder) is installed in the center of the pallet. U.S. Pat. No. 7,342,496 and U.S. Patent Publication Number 2005/0076816 discloses pallets which have RFID tags mounted thereon. Antennae elements are provided in the forks of a pallet moving apparatus, which is supposed to enable a device to obtain information from the RFID tag. U.S. Pat. Nos. 5,662,048 and 5,971,592 also relate to a pallet having a data storage device from which a data collection device can obtain information.

U.S. Pat. No. 6,669,089 is directed to a forklift with two spaced RFID antennas positioned in a column on either side of the forks of the forklift. The problem that occurs with a reader on the side of the forklift or on readers placed horizontally apart is that precise alignment of the antenna is required, the multiple tag readings of pallets or of stacks of pallets are lost or misidentified so that tracking and inventory have unacceptable loss percentages.

Unfortunately, the above references do not solve the problem of accurately identifying individual pallets as the systems pick up stray RFID tags within the warehouse leading to erroneous readings and have other pallet tags effectively screened from reading. Furthermore, when pallets are read by forklifts, issues are encountered upon widening the forks of the forklift, as RF waves are absorbed by the forklift due to presence of metal with the result that the targeted pallets reading results are inconsistent.

These teachings do not aid in the resolution of a number of practical difficulties that are resolved by the present invention.

### SUMMARY OF THE INVENTION

The present invention provides a plastic pallet tracking system for tracking of pallets in a warehouse environment. A working embodiment of the pallet tracking system comprises: a) at least one RFID reader positioned in an elevated position on a back frame of a forklift; b) at least one RFID antenna secured to the forklift body on each side of the forklift behind the mast of the forklift and above the front wheel well, the antenna being oriented parallel to the ground and directing its beam downward towards the ground; and c) a pallet including identical RFID tags in each corner to enable the RFID tags to be interrogated by an RFID reader antenna. The RFID tag readings are filtered by software which allows for separation of tag reads and the results displayed on a touch screen display mounted in the cab of the forklift.

It is an object of the invention to provide a forklift plastic pallet reading assembly which does not require precise alignment of the antennas to obtain accurate pallet readings.

Another object of the present invention provides a specifically configured forklift having a mast with RFID antennas positioned on each side of the forklift oriented downward.

It is still another object of the invention to provide a forklift system which eliminates stray reading of other pallets with filtration software.

It is yet another object of the invention to provide pallets having all four corners tagged with RFID tags which can be read using linear polarity patch RFID antenna, each individual pallet being provided with multiple, identical RFID tags located in the corners.

These and other objects, advantages, and novel features of the present invention will become apparent when considered with the teachings contained in the detailed disclosure along with the accompanying drawings.

### BRIEF DESCRIPTION OF THE DRAWINGS

The present invention will be described with reference to the appended Figures, in which:

FIG. 1 illustrates a perspective view of a forklift having a RFID reader and RFID antenna removably mounted on each side of the forklift;

FIG. 2 is a an enlarged partial top perspective view of an antenna mounted to the forklift shown in FIG. 1;

FIG. 3 is an enlarged side view of the RFID antenna of FIG. 2;

FIG. 4 is a rear perspective view of the reader mounted in the forklift;

FIG. 5 is a view of the lower cabling;

FIG. 6 is a view of the upper cabling; and

FIG. 7 is a perspective view of a stack of pallets without goods having imbedded RFID tags.

### DESCRIPTION OF THE INVENTION

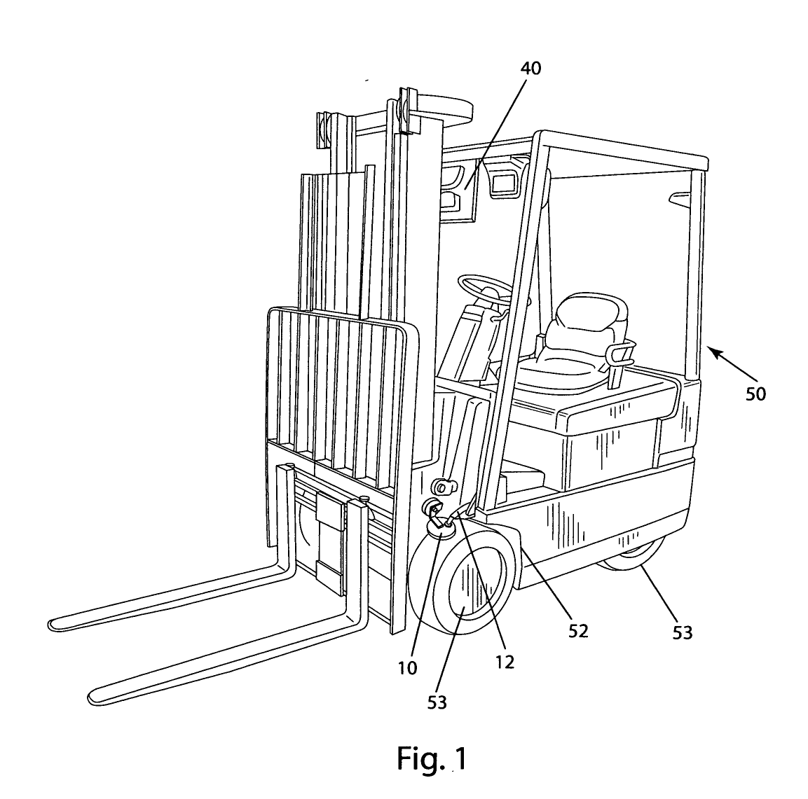

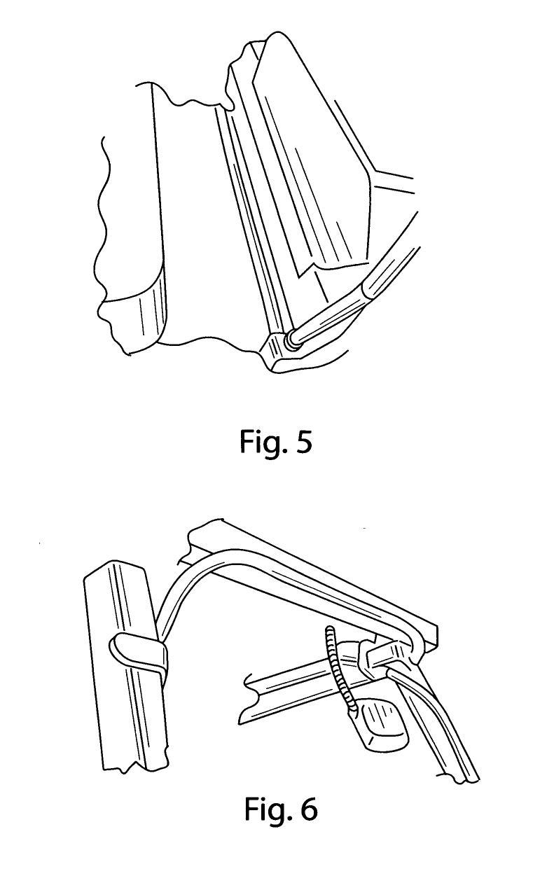

The present invention is directed toward identifying plastic pallets. The preferred embodiment and best mode of the invention is shown in FIGS. 1 through 6. The use of plastic pallets is prevalent in modern day industry and large numbers of plastic pallets are shipped and moved throughout storage facilities. The plastic pallets come in standard sizes and define fork apertures which can receive the tines of a standard forklift. Thus, there exists a need to account for and correctly inventory individual plastic pallets bearing goods and individual plastic pallets in a stack of plastic pallets. Accordingly, the present invention reads and identifies each individual plastic pallet. While the plastic pallet can be provided with one or more RFID tags, it is preferred that each plastic pallet has multiple, identical RFID tag(s) with a single RFID tag located in each corner of the plastic pallet. As a result of the tag placement, the information regarding the plastic pallet is more easily and reliably obtained when the RFID reader interrogates the RFID tag(s).

In the invention, antennas 10 and 10(a) (not shown) are mounted on opposite sides of the forklift 50 to successfully interrogate RFID tags (not shown) on individual pallets.

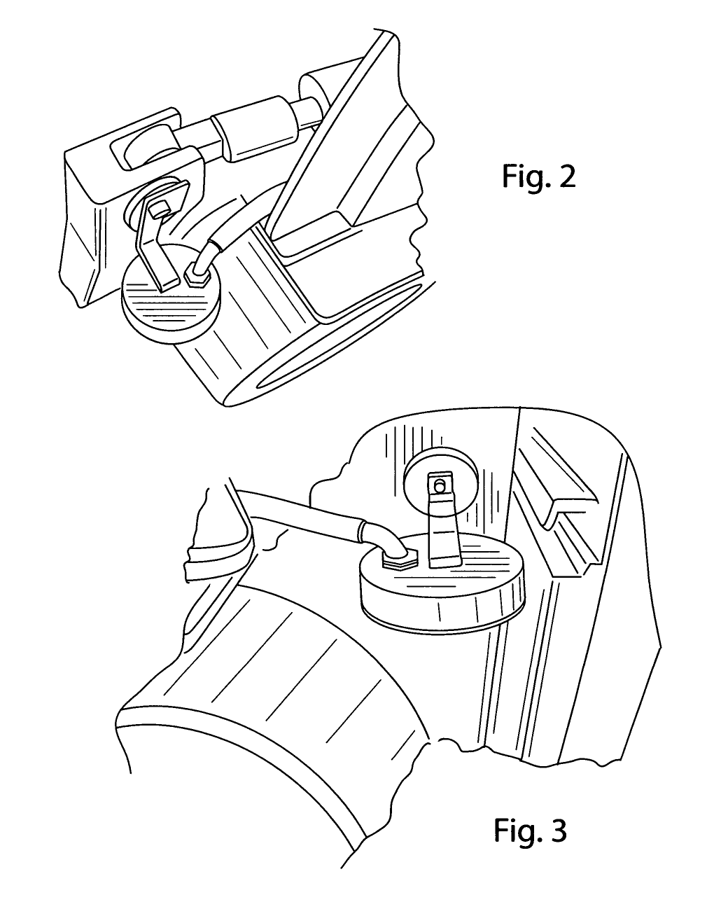

An antenna/reader array is necessary to enable the RFID forklift system to interrogate the pallets substantially simultaneously. The antennae 10 and 10(a) presently being initialized are spaced from the mast on either side of the forklift 50 at a height approximately parallel or slightly lower than the wheel well 52 of the front wheel 53 of the forklift. Each antenna 10 is preferably a patch antenna having a 900-930 MHz band providing a 3.5 dBi gain and having a linear polarity. The antenna assembly as shown in FIGS. 2 and 3 has a cylindrical housing 14 with a mounting bracket 16 secured to the top of the housing. While the top portion of the cylindrical housing is shown as opened, it is envisioned that a plastic cap can be placed over the open end to protect the patch antenna from debris, dirt, oil and other contaminants. The distal end 17 of the bracket 16 is mounted to a circular magnet 18 having a 95 pound to 160 pound pull factor. The magnet 18 preferably has a 150 pound pull factor which is under the electromagnetic interference with the antenna 10. The magnet 18 is attached to a mast or housing section of the forklift 50.

A suitable directional patch antenna which can be used in the invention is a Cotelco Antenna having a 4¼ inch diameter with a flat plate area of 0.1406 ft². It has a power rating of 50 watts and an impedance of 50 ohms and is constructed of ABS. The antenna has a range of 2 to 4 feet and is placed so that its axis is transverse to the ground and reflects down with a vertical beam width of 65° and a horizontal beam width of 60°. The antenna bracket can alternatively be welded to the forklift if magnet 18 is not used.

The antennas 10 are connected by cable 12 to a reader card housed in reader 20 which is mounted on the forklift body beside the driver seat. Readers 20 such as the Alien 9900 which can accept 2 antennas, Motorola RD5000, Motorola XR450 and Things Magic Mercury4e can be used with the invention. The antennas are hard wired to the reader RS232 port with Teflon® coated low loss cables. The preferred terminal used in the system is the LXE Touch Screen. All of the above components excepting the modified antenna in the system are standard and are readily available over the counter. It is acknowledged that other equivalent antenna, readers and screens could be used with the invention.

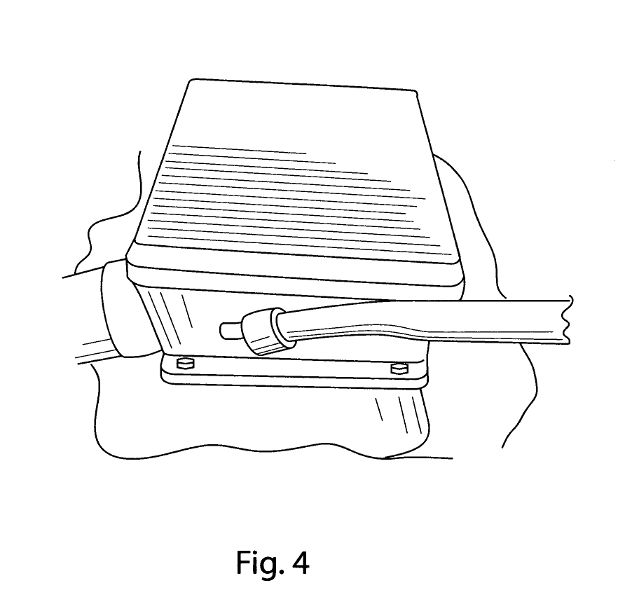

The preferred mounting and orientation for the antenna 10 in the RFID system is with the open face forming a plane which is horizontal to the ground so that the radio frequency beam is directed toward the ground and reflects off the mast. As previously noted, the antenna 10 is preferably mounted on opposite sides of the forklift and the reader 20 is positioned behind the driver as seen in FIG. 4. A touch panel 40 is connected to reader 20 by a cable 30 which is enclosed in cable housing and the touch panel 40 is connected to an inboard or remote computer and data base to allow entering and retrieval of the pallet information. The touch screen allows the operator to enter the data for a stack of pallets into the database once the pallets within a stack have been identified.

The present invention provides antennas 10 and reader 20 on forklift 50 in a specific positioned manner to obtain maximum individual RFID tagged pallet reading efficiency. As shown in FIG. 1, the positioning of the antenna 10 is such that the linear RFID signal generated by each antenna 10 can bounce off the mast, onto a plastic pallet to obtain the pallet tag read from tags carried in each corner of the pallet.

In the preferred embodiment of the invention shown in FIG. 1, a forklift 50 is equipped with RFID antennae 10 and one RFID reader 20. The RFID reader 20 is connected to a touch panel display screen 40 by a cable 30 or by wireless means well known in the art. The reader 20 is preferably mounted behind the driver on the forklift. The back frame to which the carriage is mounted is connected to a hydraulic lift system associated with mast that lifts the back frame and the carriage and forks, to elevate the pallet load. The lift system is also able to shift the frame and forks from side-to-side, and the forks themselves are typically laterally adjustable to enable them to fit under or within pallets of different dimensions. The frame and forks are movable. The tag information read by the reader is fed to a computer which uses filter software which compares tag identification for specific pallets which are being continuously read by the reader and eliminates those tags which do not show a substantially continuous read.

One particular advantage of an antenna arrangement of this type, where the antenna(e) that are provided on the fixed portion of the forklift are positioned above the wheel wells so that the signal is bounced off the ground and the mast is that essentially all of the plastic pallets can be interrogated almost simultaneously by the one antenna.

The positioning of the antennae shown in FIG. 1 provides several advantages. First, antenna is positioned so as not to obscure the forward view of the forklift operator so that operating ability of the driver is not impaired.

Cable or cables 30 are used to connect the various components of the present invention (including the RFID reader 20, a power source, a touch-panel display 40 or other user interface) and should be sufficiently durable and protected to avoid damage in the conditions to which the forklift is expected to be exposed. Cable 12 is used to connect the RFID antenna 10 with the reader 20. Forklifts are notorious for inflicting and sustaining damage, and the components and connections should, to the extent possible, be covered or otherwise protected. To the extent that cables connect components on the fixed portion of the forklift to ones on the movable part, those cables can be festooned through pulleys or other suitable structures to maintain their position and appropriate tension.

The system of the present invention as previously noted preferably also includes a user interface, such as a display 40 (which may be a touch-panel display) visible to an operator of the forklift, a keyboard, and a removable data storage device (such as a floppy disc drive, or flash memory card). The user interface preferably is adapted to display information to the operator regarding the pallets interrogated by the RFID reader antenna, the pallets (which information may be available from the RFID tags, a database, or a combination of the two), how many RFID tags were successfully interrogated, which location tag(s) are the closest, which location tags maintain a constant sensing and other information of the type described earlier. The user interface enables the operator to input additional data (for example through the touch-panel display or keyboard), such as the condition of the plastic pallet or its contents, the time that it was picked up or dropped off, the operator's identity, or other such information. The touch-screen display may also include a calibration system, so that no keyboard is required when a screen is repaired or replaced.

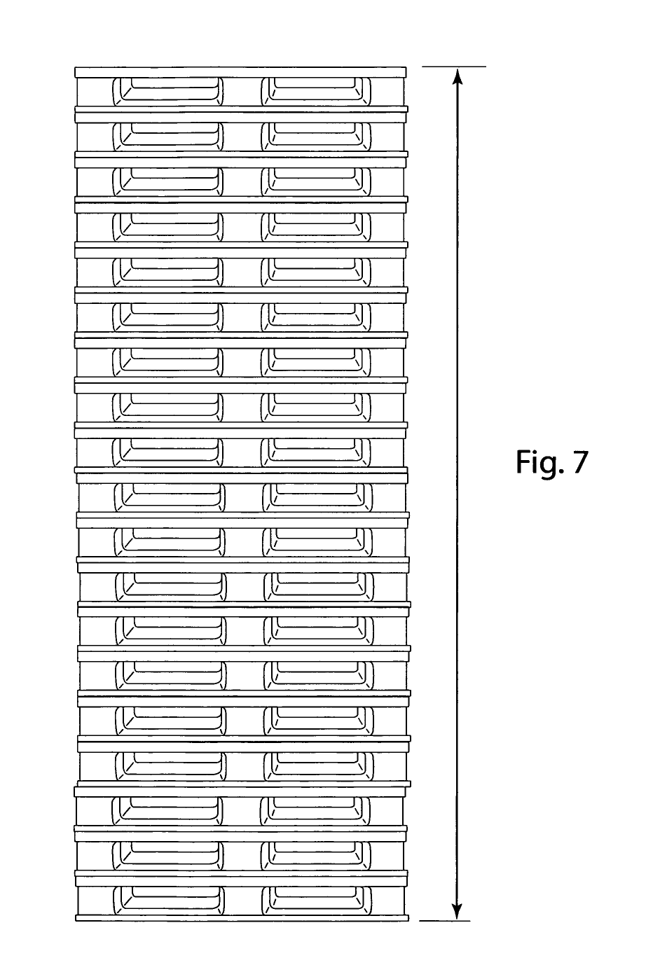

Since there are a great number of pallets on the premises it is necessary to filter the information so that only specific pallets are read. Each pallet 100 shown in a pallet stack 200 in FIG. 7 is preferably provided with four identical RFID tags inside the pallet, one RFID tag positioned in each corner of the pallet, the general location of which is shown at 104. Since the pallets are plastic, the tags 104 are buried in each corner of the pallet in an internal tube shaped support and thus protected from the outside elements. Each pallet 100 is preferably provided with RFID tags which have identical information allowing each pallet 100 to be read regardless of the direction or angle of the antenna exciter.

The advantages of the present invention are numerous and substantial. Among them are the ability to successfully interrogate multiple pallets, and the ability to approach and interrogate pallets or pallet loads from any one of four directions. Although the present invention has been described primarily with reference to pallets, persons of skill in the art will understand that these teachings can also be applied to containers, bins, racks, totes, or other storage devices.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What we claim is:

1. A forklift RFID system for identifying RFID tagged plastic pallets, with each plastic pallet being provided with RFID tags having the same RFID identification comprising:
a) a forklift comprising a body, a mast mounted to said body and a fork assembly moveably mounted on said mast;
b) RFID antenna assemblies secured in a fixed position on said forklift on each side of said forklift and oriented to direct a RFID signal downward;
c) a RFID reader positioned on said forklift and hard wired to said RFID antenna assemblies; and,
d) a user interface assembly including a touch-panel display mounted to said forklift, said RFID reader being hardwired to said touch-panel display.

2. The forklift RFID system of claim 1 wherein each said plastic pallet has an RFID tag located in each corner.

3. The system RFID system of claim 2 wherein each RFID tag for each plastic pallet gives an identical signal when interrogated by said RFID antenna assemblies.

4. The forklift RFID system of claim 1 wherein each plastic pallet is placed in a stack ranging from 10 to 19 pallets in height.

5. The forklift RFID system of claim 1 wherein each said RFID antenna assembly has an antenna with linear polarity.

6. The forklift RFID system of claim 1 wherein said RFID antenna assemblies comprise a body, a patch antenna mounted to said body and mounting means secured to said body allowing said antenna assembly to be mounted to said forklift.

7. The forklift RFID system of claim 6 wherein said mounting means is a magnet.

8. The forklift RFID system of claim 7 wherein said magnet has a pull force ranging from about 95 pounds to 160 pounds.

9. The forklift RFID system of claim 1 wherein the said RFID antenna assemblies have a range of about 2 to about 4 feet.

10. The forklift RFID system of claim 1 wherein each of said antenna assemblies includes a patch antenna having a linear signal.

11. The forklift RFID system of claim 1 wherein said touch-panel display has an associated keyboard.

12. The forklift RFID system of claim 1 wherein said touch-panel display has a removable data storage device.

13. A forklift RFID system for identifying plastic pallets having an RFID tags in at least two corners of each comprising:
a) a forklift comprising a body, a mast mounted to said body and a fork assembly moveably mounted on said mast;
b) RFID antenna assemblies removably secured in a fixed position on said forklift on each side of said forklift, said antenna assemblies being linear patch antenna oriented to primarily transmit RFID signals towards the ground;
c) a RFID reader positioned on said fork assembly and connected to said RFID antenna assemblies by cable; and,
d) a user interface assembly including a touch-panel display, said reader being hardwired to said touch-panel display.

14. The forklift RFID system of claim 13 wherein said pallets each have an RFID tag located in each corner and said RFID tags have the same identification reading.

15. The forklift RED system of claim 13 wherein said linear patch antenna have an effective range from about 2 to about 4 feet.

16. The forklift RFID system of claim 15 wherein said linear patch antenna is mounted in a cylindrical casing with a bracket member secured thereto, said bracket member having mounting means to secure it to said forklift.

17. The forklift RFID system of claim 16 wherein said mounting means is a magnet having a pull force ranging from about 95 pounds to about 160 pounds.

18. The forklift RFID system of claim 11 wherein the system further comprises software adapted to provide information to a user interface regarding an identified pallet.

19. A forklift RFID system for identifying plastic pallets tagged with RFID tags in each corner comprising:
a) a forklift comprising a body, a mast mounted to said body and a fork assembly moveably mounted on said mast, said fork assembly comprising a back frame mounted to said mast and forks mounted to said back frame;
b) RFID antenna assemblies removably secured in a fixed position on said forklift on each side of said forklift, said antenna assemblies being provided with a patch antenna of linear polarity having a cylindrical housing which is oriented parallel to the ground and directs its signal downward and magnet means mounted to said housing allowing said assemblies to be mounted to said forklift;
c) a RFID reader positioned on said fork assembly and hard wired to said RFID antenna assemblies;
d) a user interface assembly including a touch-panel display, a keyboard and a removable data storage device, said reader being electrically connected to said touch-panel display; and
e) software adapted to provide information to the touch-panel display describing which RFID tags have been interrogated by the antenna, said software including filter means which retains tag identification for specific pallets which are being continuously read by said RFID reader.
